(19) United States
(12) Patent Application Publication
(10) Pub. No.: US 2024/0077052 A1
(43) Pub. Date: Mar. 7, 2024

(54) Fuel Pump Hanger Assembly

(71) Applicant: 1340126 Ontario Inc., Ontario (CA)

(72) Inventors: Jack Levinson, Onrtario (CA); Rajan Thiru, Ontario (CA)

(21) Appl. No.: 18/242,973

(22) Filed: Sep. 6, 2023

(30) Foreign Application Priority Data
Sep. 6, 2022 (CA) 3172531

(51) Int. Cl. F02M 37/10

(52) U.S. Cl. CPC F02M 37/103

(57) ABSTRACT

A fuel pump hanger assembly configured to fit two fuel pumps into the small opening of a fuel tank, even if the diameter of both fuel pumps combined is larger than the opening of the fuel tank. The fuel pumps may be inserted into the fuel tank one at a time, then assembled together through the small opening of the fuel tank. The parts self-locate inside the fuel tank and the assembly held together with bolts. This self-locating feature facilitates the assembly of all parts inside the small opening of the fuel tank. The hanger holds two common fuel pumps and comes with fittings for interfacing to the car's fuel and vapor lines.

### RELATED APPLICATIONS

This application claims the benefit of priority to Canadian Application No. 3,172,531, filed Sep. 6, 2022, which is hereby incorporated herein by reference in its entirety.

### FIELD OF THE INVENTION

This invention relates to the general field of combustion engines, and more particularly to the field of fuel pumps.

### BACKGROUND OF THE INVENTION

As car owners modify their cars with larger turbos and stronger engine internals to support more power, the demands to increase fuel supply go up. In some instances, a larger fuel pump is not enough to increase fuel supply to meet fuel demand. In this case, a 2^{nd} fuel pump will be needed to supplement the fuel supply of the 1^{st} fuel pump.

### SUMMARY OF THE INVENTION

What is desired in one embodiment is a fuel pump hanger assembly configured to fit both fuel pumps into the small opening of a fuel tank, even though the diameter of both fuel pumps combined is larger than the opening of the fuel tank.

Therefore, there is provided a new pump hanger design that will securely hold both fuel pumps in the fuel tank while also having a modular design. This modular design allows both fuel pumps to be inserted into the fuel tank one at a time, then assembled together through the small opening of the fuel tank. The hanger is designed so that all parts self locate inside the fuel tank and is held together with bolts. This self locating feature is necessary to aid with the assembly of all parts inside the small opening of the fuel tank. The hanger holds two common fuel pumps and comes with all the fittings necessary to interface to the car's fuel and vapor lines.

In another embodiment, there is provided a variant pump hanger design for hanging only a single fuel pump.

### BRIEF DESCRIPTION OF THE DRAWINGS

FIG. 1 is a view of the inlet/outlet of the hanger head, and a side profile of the fuel pumps.

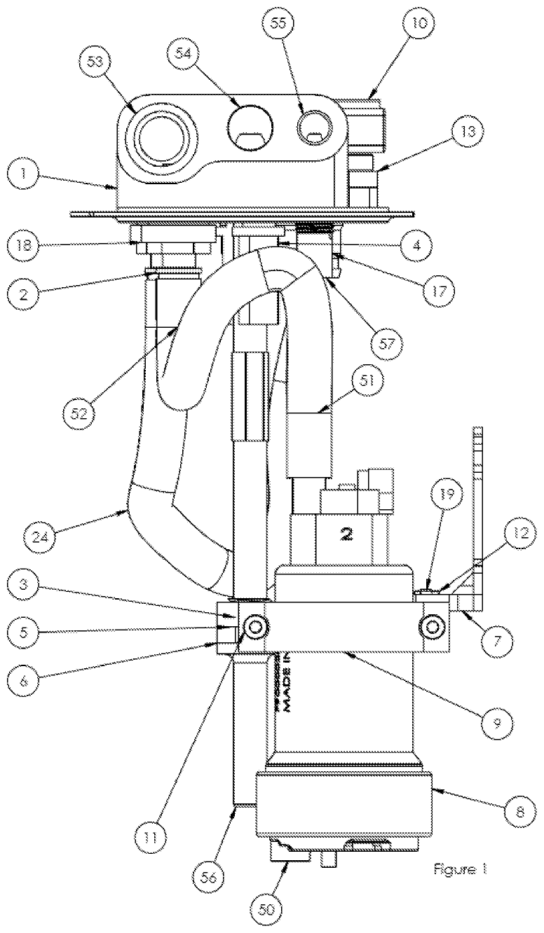

FIG. 2 is a front view of the hanger and shows the side profile of the hanger head.

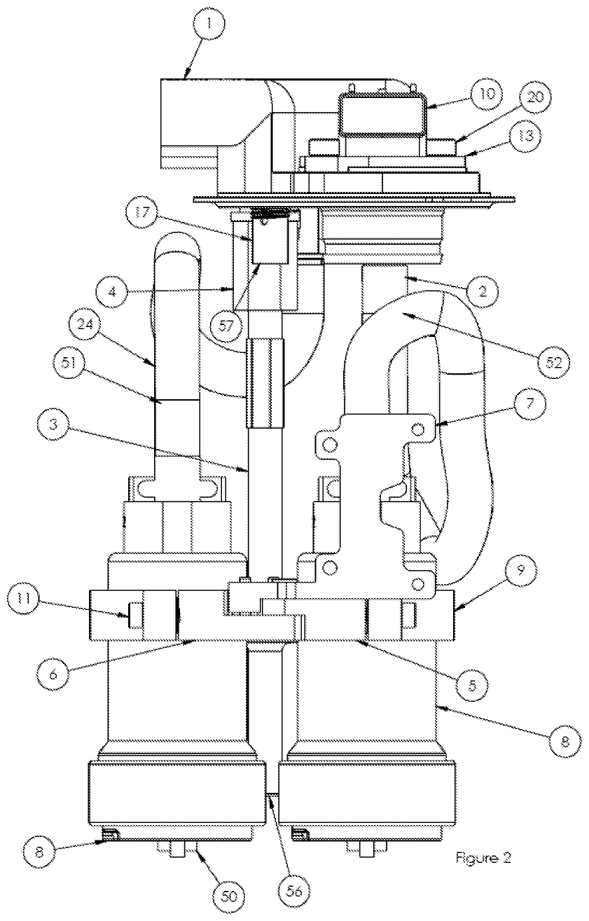

FIG. 3 is an exploded view of the hanger, showing all of the components.

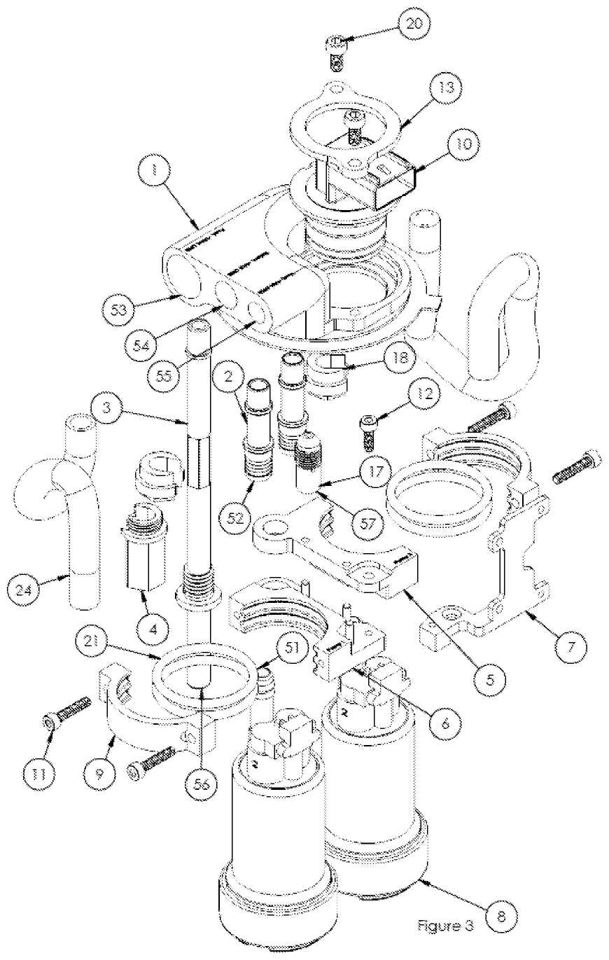

FIG. 4 is a view of the inlet/outlet of the hanger head, and a side profile of the fuel pump, of an alternative embodiment.

FIG. 5 is a front view of the hanger, and shows the side profile of the hanger head, in an alternative embodiment.

FIG. 6 is an exploded view of the hanger, showing all of the components.

### DETAILED DESCRIPTION OF THE PREFERRED EMBODIMENTS

1 is the top hat of the entire fuel pump hanger. It fastens to the fuel tank of the vehicle, fuel feed, return and vent lines which are plumbed to the ports in the top hat. The o-rings 21 are positioned around the fuel pumps 8. The o-rings are then placed into the grooves of brackets 5, 6, & 9. Bolts 11 are used to fasten bracket 9 to bracket 5 & 6. This squeezes and secures the fuel pumps 8 into place, and dampens the vibrations coming from the pumps. The large hole on bracket 6 is slipped over the top of shaft 3, and rests onto the collar on the shaft. The threaded hole on bracket 5 is then slipped over the top of shaft 3. The dowel pins on bracket 6 locates with the corresponding holes on bracket 5. Bracket 5 is then lowered and placed on top of bracket 6. Dowel pins are used for locating bracket 6 and 5 together when assembling everything inside the fuel tank. The thread on shaft 3 then screws into the threaded hole on bracket 5. Bracket 7 holds the fuel level sensor and also secures the front of bracket 5 and 6 together with bolt 12. The last dowel pin on bracket 6 interfaces with the hole on bracket 7. Bolt 12 is inserted into the counterbored hole on bracket 7 and fastens brackets 5,6, & 7 together. The top of shaft 3 is inserted into a hole on top hat 1, and secured using the longer crescent nut 4. 2 is a quick connect fitting that allows the convoluted fuel tubes 24 to feed the top hat. This custom fitting (2) allows for easy assembly in tight spaces as it allows the fuel tubes to be swiveled and positioned easily without binding. 2 is held in place with 18, which is a crescent style nut that allows you to install the threaded nuts over a cylinder that is already pressed into a hole. The vapor-proof electrical bulkhead 10 fits into the large hole on the top of the top hat, it is sealed with an o-ring underneath. Bracket 13 is placed on top of electrical bulkhead 10 and is fastened with bolts 20.

Fuel is sucked into the fuel pumps via inlets 50. Fuel leaves the fuel pumps via port 51 then is fed to port 52 with submersible fuel tubes 24. The fuel then enters a cavity in the top hat and is fed to the fuel line via port 53. Not all fuel will be consumed by the engine, some fuel will be returned back to the fuel tank. The return line from the engine feeds fuel back into the tank via port 54. The fuel then travels down the hollow shaft 3 and exits into the fuel tank via port 56. Fitting 17 is a roll-over check-valve that allows fuel vapor to exit the tank, which prevents the fuel tank from being pressurized as fuel heats and expands in the tank. The roll-over check-valve also prevents fuel from exiting the tank should the vehicle become inverted due to a collision etc. Excess vapor pressure is fed into port 57, enters a cavity in the top hat 1, then exits the top hat via port 55.

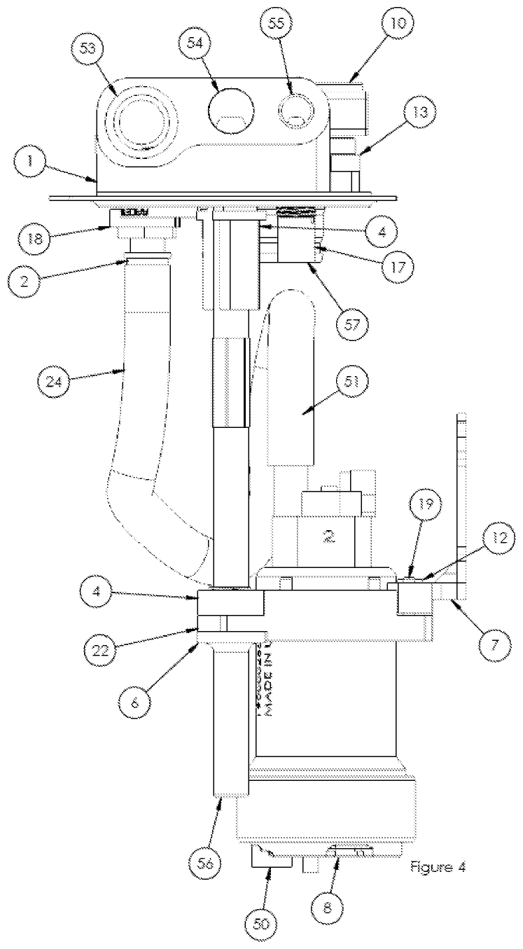

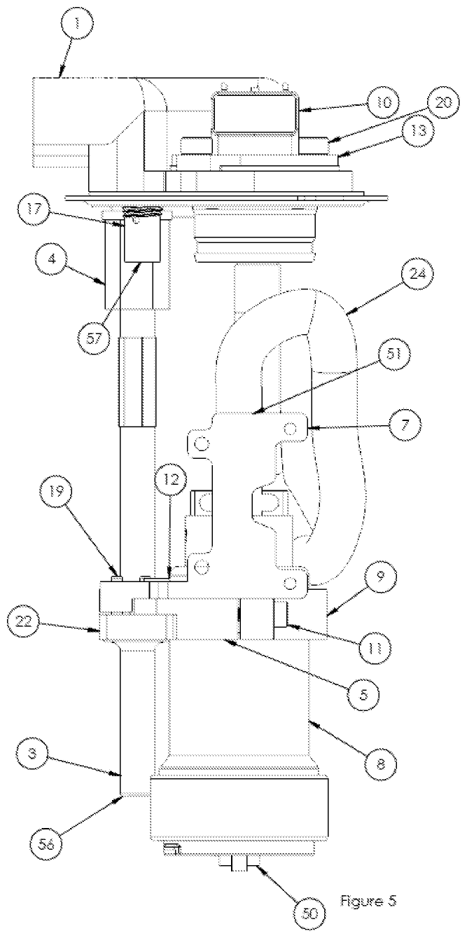

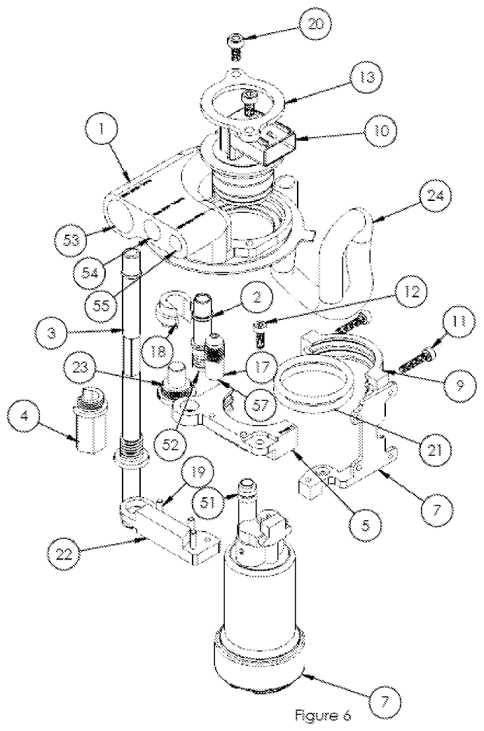

FIGS. 4, 5 and 6 show a different configuration with only one fuel pump instead of two. The change to one fuel pump requires some brackets and fittings to be swapped. Bracket 6 is replaced with Bracket 22. Bracket 22 permits elimination of the 1^{st} fuel pump while also maintaining proper spacing so that all the brackets can be assembled together. One of each fitting 2 and 18 is removed from the assembly and replaced with plug 23.

1. A fuel pump hanger comprising a self-locating hanger structure to facilitate assembly of the hanger structure through a small opening of a fuel tank.

2. A fuel pump hanger as claimed in claim 1, wherein the hanger is configured to hang two fuel pumps.

3. A fuel pump hanger as claimed in claim 1, wherein the hanger is configured to hang a single fuel pump.
